(19) United States
(12) Patent Application Publication
(10) Pub. No.: US 2015/0012688 A1
(43) Pub. Date: Jan. 8, 2015

(54) COMPUTER SYSTEM AND OPERATING METHOD THEREOF

(71) Applicants: INVENTEC CORPORATION, TAIPEI CITY (TW); Inventec (Pudong) Technology Corporation, Shanghai (CN)

(72) Inventor: Li ZHANG, Shanghai (CN)

(73) Assignees: INVENTEC CORPORATION, TAIPEI CITY (TW); Inventec (Pudong) Technology Corporation, Shanghai (CN)

(21) Appl. No.: 14/018,437

(22) Filed: Sep. 5, 2013

(30) Foreign Application Priority Data
Jul. 2, 2013 (CN) 201310272910.0

(51) Int. Cl. G06F 12/02

(52) U.S. Cl. CPC G06F 12/0246
USPC 711/103; 711/173

(57) ABSTRACT

A computer system and an operating method thereof are disclosed herein. The operating method includes: dividing a file into a plurality of file segments; transmitting the file segments to an integrated circuit (IC) sequentially: receiving, through the IC, the file segments sequentially, and writing an operating file segment in a target storage page of a target block when the operating file segment is received; determining whether the operating file segment s successfully written in the target storage page; commanding the IC to erase the target block in a case that the operating file segment is not successfully written in the target storage page; searching a re-transmission start file segment corresponding to a start address of the target block; and, sequentially transmitting a plurality of remaining file segments of the file started from the re-transmission start file segment to the IC.

### RELATED APPLICATIONS

This application claims priority to Chinese Application Serial Number 201310272910.0, filed Jul. 2, 2013, which is herein incorporated by reference.

### BACKGROUND

1. Field of Invention

The invention relates to an electronic system and an operating method to thereof. More particularly, the invention relates to a computer system including an integrated circuit (IC) and an operating method thereof.

2. Description of Related Art

With the rapid development of electronic science and technology, computer systems of different types have been widely applied in people's life, such as a personal computer or a server.

Generally, the computer system may include an integrated circuit (IC) and a storage device for storing the firmware of the IC. Generally during updating of the firmware of the IC, a firmware update file is transmitted to the IC, and the operation of writing the firmware update file is performed through the IC.

However, in actual operation the transmission success rate of the firmware update file is depended on actual hardware conditions (e.g., the length of a bus, processing rate of the IC, and the cache space of the IC), such that it cannot ensure transmission success of the firmware update file. If the transmission of the firmware update file is failed, then the computer system re-transmits the whole firmware update file, which thus will waste a large amount of time and cause reduction of firmware update efficiency.

Therefore, it is an important issue in the current electronic science and technology how to improve the firmware update efficiency of the computer system.

### SUMMARY

An aspect of the invention provides an operating method. According to an embodiment of the invention, the operating method is applied to a computer system. The computer system includes an integrated circuit (IC) and a storage device. The storage device includes a plurality of blocks. Each of the blocks includes a plurality of storage pages. The operating method includes: dividing a file into a plurality of file segments; transmitting the file segments to the integrated circuit (IC) sequentially; receiving, through the IC, the file segments sequentially, and writing an operating file segment in a target storage page of a target block when the operating file segment is received; determining whether the operating file segment is successfully written in the target storage page; commanding the IC to erase the target block in a case that the operating file segment is not successfully written in the target storage page; searching a re-transmission start file segment corresponding to a start address of the target block; and, sequentially transmitting a plurality of remaining file segments of the file started from the re-transmission start file segment to the IC.

Another aspect of the invention provides a computer system. According to an embodiment of the invention, the computer system includes a storage device, an integrated circuit (IC) and a control device. The storage device includes a plurality of blocks, each of which includes a plurality of storage pages. The control device is used for dividing a file into a plurality of file segments and transmitting the file segments to the IC sequentially. The IC is used for receiving the plurality of file segments sequentially and writing an operating file segment in a target storage page of a target block when the operating file segment is received. The control device is used for determining whether the operating file segment is successfully written in the target storage page. The control device is used for commanding the IC to erase the target block in a case that the operating file segment is not successfully written in the target storage page; searching a re-transmission start file segment corresponding to a start address of the target block; and, sequentially transmitting a plurality of remaining file segments of the file started from the re-transmission start file segment to the IC.

In view of the above, by applying one of the above embodiments, in a case that the IC fails to receive or write the file segment, the control device can just re-transmit part of the file segment to the IC, so that the update efficiency of the computer system can be increased significantly.

### BRIEF DESCRIPTION OF THE DRAWINGS

FIG. 1 is a schematic view of a computer system illustrated according to an embodiment of the invention;

FIG. 2 is a schematic view of a storage device illustrated according to an embodiment of the invention;

FIG. 3 is a schematic view of a storage page illustrated according to an embodiment of the invention;

FIG. 4 is a flow chart of an operating method of a computer system illustrated according to an embodiment of the invention; and

FIG. 5 is a schematic view of a file illustrated according to an embodiment of the invention.

### DETAILED DESCRIPTION

The spirit of the disclosure will be described clearly through the drawings and the detailed description as follows. Any of those of ordinary skills in the art can make modifications and variations from the technology taught in the disclosure after understanding the embodiments of the disclosure, without departing from the sprite and scope of the disclosure.

The phrases “first”, “second” and the like used herein are neither intended to specifically designate a sequence or order nor intended to limit the disclosure, and are only used to identify elements or operations described through the same technical terms.

Additionally, the phrase “electrically connecting” used herein may refer to that two or more elements physically or electrically contact with each other directly or indirectly, or refer to that two or more elements inter-operate or interact with each other.

An implementation aspect of the invention provides a computer system. For purpose of dear illustration, a server is taken as an example illustrated in the following paragraphs. However, the invention is not limited to this.

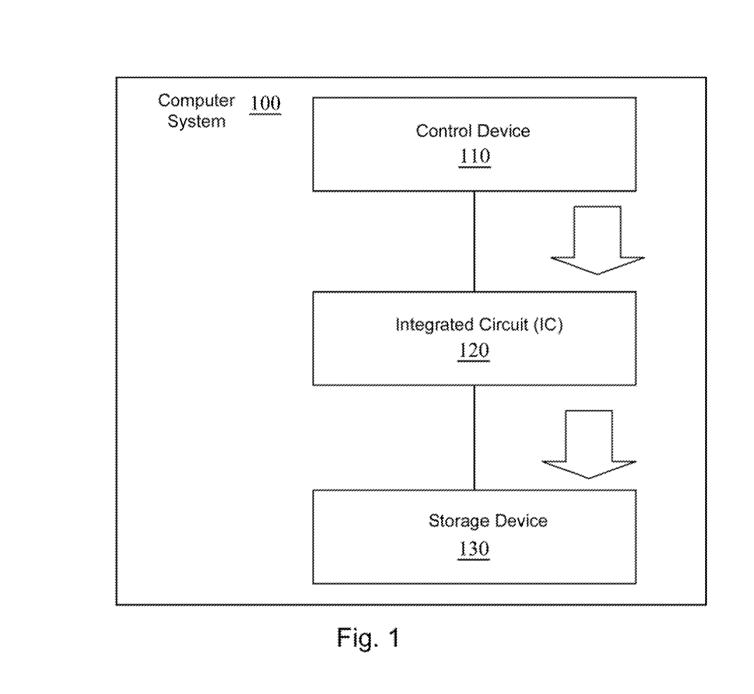

FIG. 1 is a schematic view of a computer system 100 illustrated according to an embodiment of the invention. In this embodiment, the computer system 100 includes a control device 110, an integrated circuit (IC) 120 and a storage device 130. The control device 110 may be electrically connected to the IC 120 through serial buses such as inter-integrated circuit (I²C), serial peripheral interface bus (SPI bus) and keyboard controller style (KCS). The IC 120 may to be electrically connected to the storage device 130 through the serial buses such as I²C, S-bus and KCS. However, it should be noted that connection relationships and manners of various devices in the computer system 100 are not limited to this and all of the connection relationships and manners which enables the computer system 100 to achieve the following technical content can be applied to the invention.

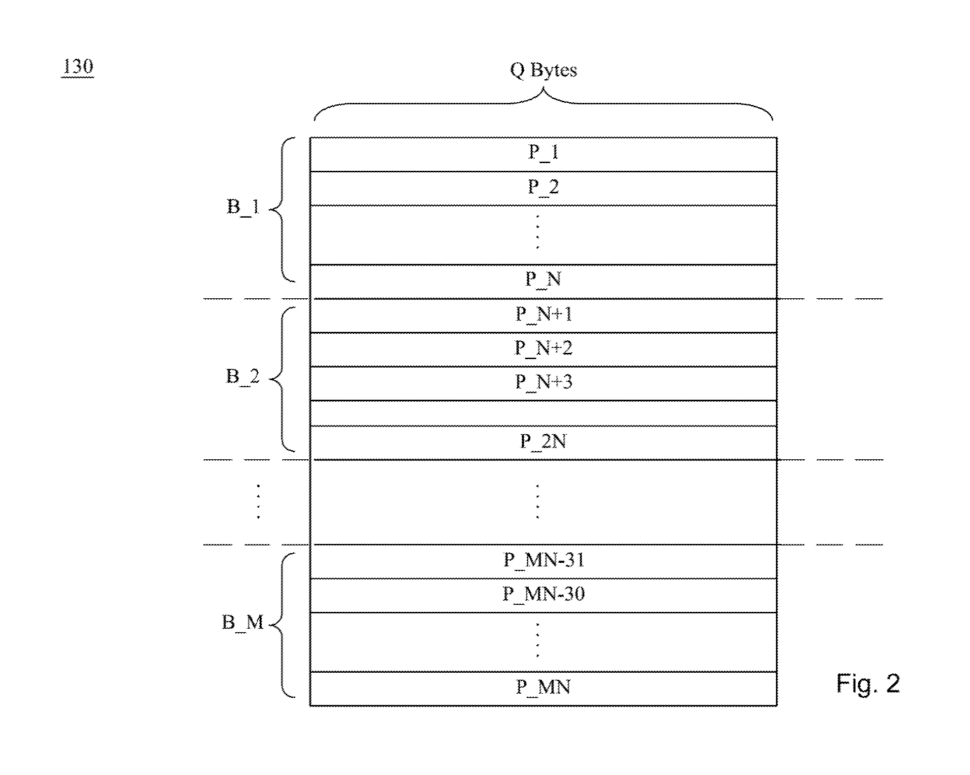

Also referring to FIG. 2, it is a schematic view of the storage device 130 illustrated according to an embodiment of the invention. In this embodiment, the storage device 130 may include a plurality of blocks (e.g., M blocks including B_{—}1, B_{—}2, . . . B_M, wherein M is a natural number). Each of the blocks may include a plurality of storage pages (for example the block B_{—}1 may include storage pages P_{—}1 P_{—}2 . . . P_N; the block B_{—}2 may include storage pages P_N+1, P_N+2, . . . P_{—}2N; and the block B_M may include storage pages P_MN−31, P_MN−30, . . . P_MN, wherein N is an natural number). Each of the storage pages may include a plurality of Bytes (e.g., Q Bytes). In an embodiment of the invention, M is 4096, N is 32, and Q is 528, so that the total space of the storage device 130 is 4096×32×528 (Byte)=66M (Byte). It should be noted that the numerical values of the aforesaid parameters M, N and Q are only described for illustration, and the invention is not limited to this.

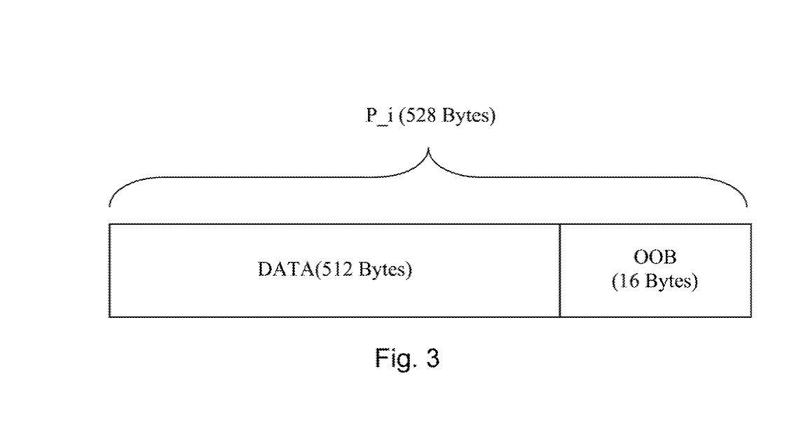

Additionally, also referring to FIG. 3, it is a schematic view of a storage page P_i illustrated according to an embodiment of the invention, wherein i is any natural number between 1 and MN. In this embodiment, each of the storage pages P_{—}1, P_{—}2 . . . P_MN for example includes a data portion DATA and a check portion OOB. In a case each of the storage pages P_{—}1, P_{—}2, . . . P_MN stores 528 Bytes, the data portion DATA has 512 Bytes, and the check portion OOB has 16 Bytes. In other words, the data storage space of the storage device 130 is 4096×32×528 (Byte)=64M (Byte). Additionally in an embodiment, the check portion OOB of each of the storage pages P_{—}1, P_{—}2, . . . P_MN stores a check code corresponding to the content of the data portion DATA. In this embodiment, the storage device 130 for example may be embodied through flash memories such as NAND flash memories and NOR flash memories, or embodied through other appropriate non-volatile storage devices such as a secure digital memory card (SD card). The storage device 130 can be used for storing the firmware file of the IC 120.

In this embodiment, the control device 110 can be embodied through a central processing unit (CPU), a microprocessor or other appropriate devices. The control device 110 can be used to run a firmware update software (such as a flash tool or other appropriate software), so as to perform firmware update of the IC 120.

Furthermore in this embodiment, the IC 120 may be a baseboard management controller (BMC), a basic input output system (BIOS) or other IC-based elements or systems. The IC 120 can be used for receiving a firmware update file and writing the firmware update file into the storage device 130, so as to perform firmware update of the IC 120.

Specific details of the invention will be further described as follows through the operating method. The operating method can be applied to a computer system same as or similar to the computer system 100 of FIG. 1, and for purpose of simplicity in description, according to an embodiment of the invention the computer system 100 of FIG. 1 is taken as an example to describe the operating method, but the invention is not limited to this application.

Additionally, it should be noted that the sequence of the steps of the aforesaid operating method stated in the above embodiments can be adjusted according to actual demands, or even all or parts of the steps can be performed simultaneously, unless otherwise the sequences are stated clearly.

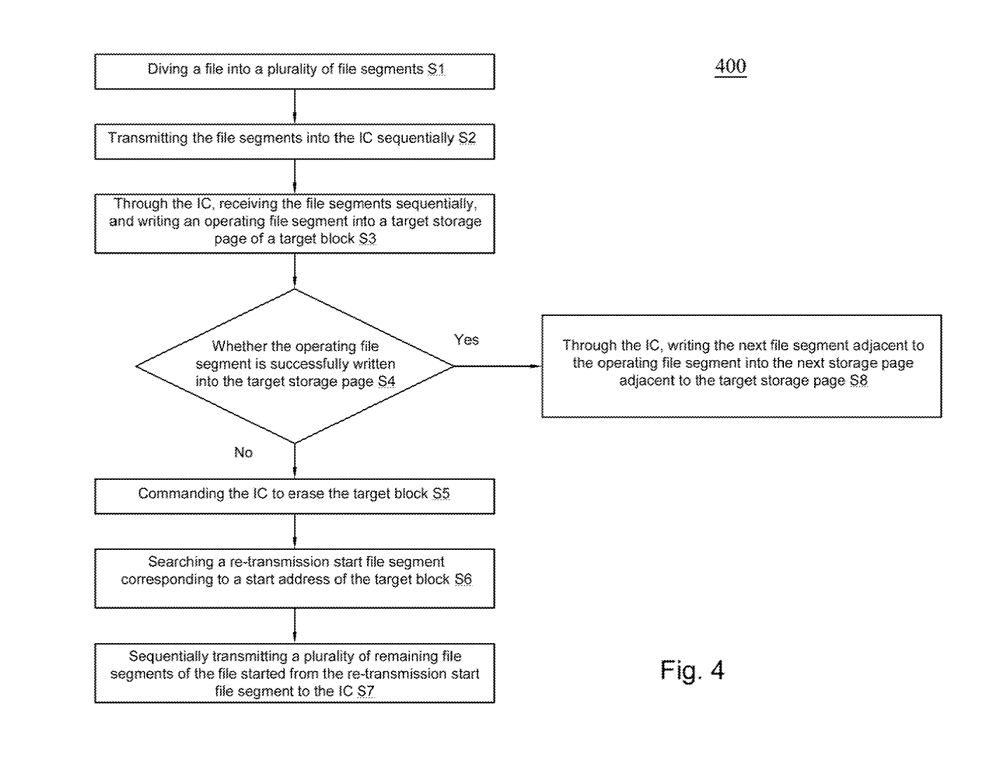

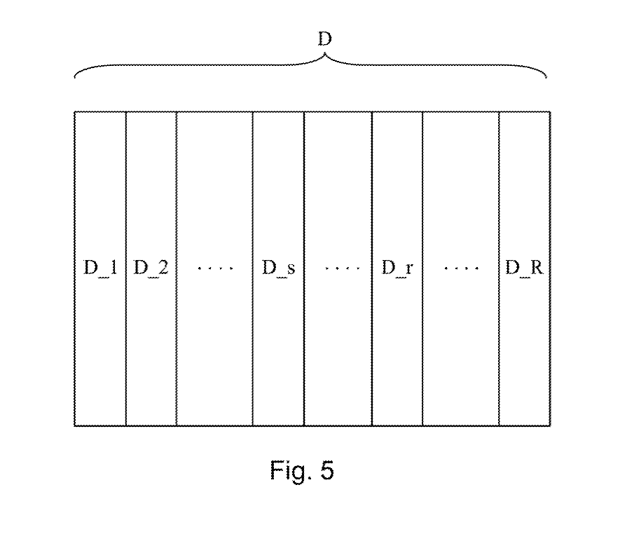

References are made to FIGS. 1-5, wherein FIG. 4 is a flow chart of an operating method 400 of the computer system illustrated according to an embodiment of the invention, and FIG. 5 is a schematic view of a file D illustrated according to an embodiment of the invention. The operating method 400 includes the following steps.

In step S1, the control device 110 divides the file D (such as but not limited to the firmware update file) into a plurality of file segments D_{—}1, D_{—}2, . . . D_R (as shown in FIG. 5), wherein R is a natural number. The data length of each of the file segments D_{—}1, D_{—}2, . . . D_R for example is smaller than or equal to that of the data portion DATA of each of the storage pages P_{—}1, P_{—}2, . . . P_MN. For example in a case the data portion DATA of each of the storage pages P_{—}1, P_{—}2, . . . P_MN stores 512 Bytes, the data length of each of the file segments D_{—}1, D_{—}2, . . . D_R may be less than or equal to 512 Bytes.

In step S2, the control device 110 can sequentially transmit the file segments D_{—}1, D_{—}2, . . . D_R to the IC 120.

In step S3, the IC 120 can sequentially receive the file segments D_{—}1, D_{—}2, . . . D_R, and write an operating file segment D_r into a target storage page P_n included in the storage pages in a target block B_m of the blocks B_{—}1, B_{—}2, . . . B_M in the storage device 130 when the operating file segment D_r included in the file segments D_{—}1, D_{—}2, . . . D_R is received. Herein r is any to natural number between 1 and R, m is any natural number between 1 and M, and n is any natural number between 1 and MN.

In step S4, the control device 110 can determine whether the operating file segment D_r is successfully written in the target storage page P_n. If so then step S5 is performed; and if not then step S8 is performed.

In step S5, in a case the operating file segment D_r is not successfully written into the target storage page P_n, the control device 110 can command the IC 120 to erase the target block B_m. For example the control device 110 can command the IC 120 to set all the bits in the target block B_m as the numeral value “1”.

In step S6, the control device 110 can search the a re-transmission start file segment D_s included in the file segments D_{—}1, D_{—}2, . . . D_R, corresponding to a start address of the target block B_m, wherein s is a natural number less than or equal to r. The start address of the target block B_m is for example the storage page address of the first storage page included in the target block. B_m. It should be noted that the sequence of the steps S5 and S6 can be interchanged, not limited to the sequence shown in FIG. 4.

In step S7, the control device 110 can sequentially transmit the remaining file segments D_s, D_s+1, . . . D_R included in the file segments D_{—}1, D_{—}2, . . . D_R, started from the re-transmission start file segment D_s, to the IC 120.

Additionally, in step S8 in a case the operating file segment D_r is successfully written into the target storage page P_n, if r is less than R, the IC 120 can write the next file segment D_r+1 adjacent to the operating file segment D_r into the next storage page P_n+1 adjacent to the target storage page P_n For simplicity of understanding, exemplary examples for operation are taken as examples hereafter to illustrate the aforesaid embodiments of the invention, but the invention is not limited to this.

In an exemplary example, the control device 110 divides the file D into a plurality of file segments D_{—}1, D_{—}2, . . . D_R, and transmits the file segments D_{—}1, D_{—}2, . . . D_R to the IC 120 sequentially. The IC 120 receives the file segments D_{—}1, D_{—}2, . . . D_R, and sequentially writes the file segments D_{—}1, D_{—}2, . . . D_R into storage pages P_{—}1, P_{—}2, . . . P_MN. When receiving the operating file segment D_r, the IC 120 writes the operating file segment D_r into the target storage page P_n of the target block B_m, for example into the storage page P_N+2 of the block B_{—}2. Subsequently, the control device 110 determines whether the operating file segment D_r is successfully written into the storage page P_N+2 of the block B_{—}2.

In a case the operating file segment D_r is not successfully written into the storage page P_N+2, the control device 110 commands the IC 120 to erase the block B_{—}2 and searches the re-transmission start file segment D_s corresponding to a start address of the block B_{—}2 (such as the address of the storage page P_N+1). Subsequently, the control device 110 sequentially transmits the remaining file segments D_s, Ds+1, . . . D_R started from the re-transmission start file segment D_s to the IC 120. Additionally, in a case the operating file segment D_r is successfully written into the storage page P_N+2 of the block B_{—}2, if r is less than R, the control device 110 writes the next file segment D_r+1 adjacent to the operating file segment D_r into the storage page P_N+3.

Via the aforesaid steps, in a case that the IC 120 fails to receive or write to the file segment, the control device 110 can just re-transmit part of the file D to the IC 120, so that the update efficiency of the computer system 110 can be increased significantly.

More specific implementation details of the aforesaid operating method 400 will be provided in the following paragraphs, but the invention is not limited to this.

According to an embodiment of the invention, before the aforesaid step S1 the IC 120 can pre-erase the blocks 13_{—}1, B_{—}2, . . . B_M as units of the storage device 130. That is, all of the bits included in the blocks B_{—}1, B_{—}2, . . . B_M are set as the numeral value “1”.

According to an embodiment of the invention, in the aforesaid step S2 the control device 110 can record a plurality of file segment addresses AD_{—}1, AD_{—}2, . . . AD_R corresponding to the transmitted file segments D_{—}1, D_{—}2, . . . D_R, wherein the file segment addresses AD_{—}1, AD_{—}2, . . . AD_R for example are the addresses of the file segments D_{—}1, D_{—}2, . . . D_R in the file D, or may be preset addresses of the file segments D_{—}1, D₂2, . . . D_{R} to be written in the storage pages P_{—}1, P_{—}2, . . . P_MN of the storage device 130.

Furthermore, in the aforesaid step S3 the control device 110 can calculate the target block address AB_m of the target block B_m according to the operating file segment address AD_r corresponding to the operating file segment D_r in the file segment addresses AD_{—}1, AD_{—}2, . . . AD_R, wherein the target block address AB_m is for example the address of the target block B_m in the storage device 130. Subsequently, the control device 110 can command the IC 120 to erase the target block B_m according to the target block address to AB_m.

According to an embodiment of the invention, in the aforesaid step S4 the IC 120 can generate a check code and feed back the check code to the control device 110. Subsequently, the control device 110 can determine whether the operating file segment Dr is successfully written into the target storage page P_n according to whether the check code is received or whether the check code is correct. In an embodiment, the manner of generating the check code for example may be reading the check portion OOB of the target storage page P_n as the check code, or calculating the check code according to the data portion DATA of the target storage page P_n.

According to an embodiment of the invention, in the aforesaid step S7 after the target block B_m is erased, the IC 120 can provide an erase success signal to the control device. Subsequently after the erase success signal is received, according to the erase success signal the control device 110 can sequentially transmit the remaining file segments D_s, D_s+1, . . . D_R included in the file segments D_{—}1, D_{—}2, . . . D_R to the IC 120.

Additionally, according to an embodiment of the invention after all of the file segments D_{—}1, D_{—}2, . . . D_R are written into the storage pages P_{—}1, P_{—}2, . . . P_MN of the storage device 130, the IC 120 can calculate a total check code and feed back the total check code to the control device 110. Then according to the total check code, the control device 110 can confirm whether all of the file segments D_{—}1, D_{—}2, . . . D_R are successfully written into the storage pages P_{—}1, P_{—}2, . . . P_MN of the storage device 130.

Furthermore, according to an embodiment of the invention all of the aforesaid steps have a retrying mechanism used for retrying when an error occurs, so as to recovery automatically.

Although the invention has been disclosed with reference to the above embodiments, these embodiments are not intended to limit the invention. It will be apparent to those of skills in the art that various modifications and variations can be made without departing from the spirit and scope of the invention. Therefore, the scope of the invention shall be defined by the appended claims.

What is claimed is:

1. An operating method applied to a computer system, wherein the computer system comprises an integrated circuit (IC) and a storage device, wherein the storage device comprises a plurality of blocks and each of the blocks comprises a plurality of storage pages, and the operating method comprises:
dividing a file into a plurality of file segments;
transmitting the file segments into the integrated circuit (IC) sequentially;
receiving, through the IC, the file segments sequentially and writing an operating file segment comprised in the file segments into a target storage page comprised in the storage pages of a target block when the operating file segment is received;
determining whether the operating file segment is successfully written into the target storage page;
commanding the integrated circuit (IC) to erase the target block in a case the operating file segment is not successfully written into the target storage page;
searching a re-transmission start file segment corresponding to a start address of the target block in the file segments; and
sequentially transmitting remaining file segments comprised in the file segments, started from the re-transmission start file segment to the integrated circuit (IC).

2. The operating method of claim , further comprising:
recording a plurality of file segment addresses corresponding to the transmitted file segments.

3. The operating method of claim 1, wherein the step of commanding the integrated circuit (IC) to erase the target block further comprises:
calculating a target block address of the target block according to an operating file segment address corresponding to the operating file segment; and
commanding the integrated circuit (IC) to erase the target block according to the target block address.

4. The operating method of claim 1, wherein the step of determining whether the operating file segment is successfully written into the target storage page comprises:
through the integrated circuit (IC), generating a check code; and
determining whether the operating file segment is successfully written into the target storage page according to whether the check code is received or whether the check code is correct.

5. The operating method of claim 4, wherein each of the storage pages comprises a data portion and a check portion, and the step of generating the check code further comprises:
reading the check portion of the target storage page as the check code, or calculating the check code according to the data portion of the target storage page.

6. The operating method of claim 1, wherein the step of sequentially transmitting remaining file segments comprised in the file segments, started from the re-transmission start file segment to the integrated circuit (IC) further comprises:
after the target block is erased, through the integrated circuit (IC), providing an erase success signal; and
according to the erase success signal, sequentially transmitting the remaining file segments comprised in the file segments, started from the re-transmission start file segment to the integrated circuit (IC).

7. The operating method of claim 1, further comprising:
after all of the file segments are written into the storage pages, calculating a total check code through the integrated circuit (IC); and
according to the total check code, confirming whether the file segments are successfully written into the storage pages,

8. The operating method of claim 1, wherein the storage device is a flash memory.

9. A computer system, comprising:
a storage device comprising a plurality of blocks, each of which comprising a plurality of storage pages;
an integrated circuit (IC); and
a control device used for dividing a file into the file segments and transmitting the file segments to the IC sequentially,
wherein the integrated circuit (IC) is used for receiving the plurality of file segments sequentially and writing an operating file segment comprised in the file segments into a target block comprised in the blocks when the operating file segment is received, the control device is used for determining whether the operating file segment is successfully written into the target storage page, and in a case the operating file segment is not successfully written into the target storage page the control device commands the integrated circuit (IC) to erase the target block, and the control device is also used for searching a retransmission start file segment corresponding to a start address of the target to block in the file segments and sequentially transmitting the remaining file segment comprised in the file segments, started from the re-transmission start file segment, to the integrated circuit (IC).

10. The computer system of claim 9, wherein the control device is further used for recording a plurality of file segment addresses corresponding to the file segments transmitted by the control device.

11. The computer system of claim 9, wherein the control device is further used for calculating a target block address of the target block according to an operating file segment address corresponding to the operating file segment, and commanding the integrated circuit (IC) to erase the target block according to the target block address.

12. The computer system of claim 9, wherein the integrated circuit (IC) is further used for generating a check code and transmitting the check code to the control device, and the control device is further used for determining whether the operating file segment is successfully written into the target storage page according to whether the check code is received or whether the check code is correct.

13. The computer system of claim 12, wherein each of the storage pages comprises a data portion and a check portion, and the integrated circuit (IC) is further used for reading the check portion of the target storage page as the check code or calculating the check code according to the data portion of the to target storage page.

14. The computer system of claim 9, wherein after the target block is erased, the integrated circuit (IC) provides an erase success signal to the control device, and the control device is used for, according to the erase success signal, sequentially transmitting the remaining file segments comprised in the file segments, started from the re-transmission start file segment to the integrated circuit (IC).

15. The computer system of claim 9, wherein the integrated circuit (IC) is further used for calculating a total check code after all of the file segments are written into the storage pages, and the control device is further used for confirming whether the file segments are successfully written into the storage pages according to the total check code.

16. The computer system of claims 9, wherein the storage device is a flash memory.
